(19) United States
(12) Patent Application Publication
(10) Pub. No.: US 2021/0373040 A1
(43) Pub. Date: Dec. 2, 2021

(54) Thermoelectric temperature controlled sample holder for biomedical analyzers

(71) Applicant: Danny Labes, Chatel-Saint-Denis (CH)

(72) Inventor: Danny Labes, Chatel-Saint-Denis (CH)

(21) Appl. No.: 16/886,802

(22) Filed: May 29, 2020

(51) Int. Cl. G01N 35/00

(52) U.S. Cl. CPC G01N 35/00584; G01N 2035/00445; G01N 2035/00356; G01N 35/00029

(57) ABSTRACT

The present invention relates to the field of temperature monitoring and controlling apparatus, more particularly, relates to a thermoelectric temperature controlled sample holder for biomedical analyzers used for the processing of biological samples. Specifically, in biomedical research, samples of single cell suspensions are loaded into a biomedical analyzer, e.g. a flow cytometer for analysis. Some flow cytometers are equipped with multi sample loaders that hold for instance microtiter plates which can contain multiple, up to thousands of samples. Processing of all samples is done sequentially, sample after sample and may take several hours between the first to the last sample. Depending on the type of analysis it may be useful to maintain the samples at a defined temperature for example, to maintain viability and integrity of the sample or to keep biological processes running at physiological temperatures. The present invention allows to maintain the sample holder at definable temperatures between 3° C. to 70° C.

### CROSS-REFERENCE TO RELATED APPLICATIONS

No related applications are previously filed.

### TECHNICAL FIELD OF THE INVENTION

The present invention relates to the field of temperature monitoring and controlling apparatus, more particularly, relates to a thermoelectric temperature controlled sample holder for biomedical analyzers used for the processing of biological samples.

### BACKGROUND OF THE INVENTION

Flow cytometry is a technique used to detect and measure physical and chemical characteristics of a population of cells or particles. In this process, a sample containing cells or particles is suspended in a fluid and injected into the flow cytometer instrument. Maintaining the temperature of the samples is one of the crucial aspects when loading and processing the samples using flow cytometry. The lack of temperature control may lead to loss of cell count in the biological sample that may further lead to false results.

Some thermal management solutions have been developed by different manufacturers that predominantly fall into two categories: active and passive temperature control and management. Active temperature control systems utilize compressor or solid-state (thermoelectrics) based water baths to cool below ambient temperatures. Passive thermal management solutions solely rely on heat transfer by conduction, or convection to transfer heat and are typically comprised of interface materials and heat sinks and fans. Passive technologies are most commonly used where cooling to ambient temperature is sufficient.

A research article authored by Ware and Schaefer details the effects of time and temperature on flow cytometry enumerated live Cryptosporidium parvum oocysts. In this research the authors identified that replicate samples containing 100 live C. parvum oocysts were prepared by flow cytometry and stored at 4° C., room temperature and 37° C. These samples were counted at various time points. Significant oocyst losses were observed after storage for 1 day at 37° C., 7 days at room temperature and 21 days at 4° C.

In biomedical research, samples of single cell suspensions are loaded into a biomedical analyzer, e.g. a flow cytometer for analysis. Some flow cytometers are equipped with multi sample loaders that hold for instance microtiter plates which can contain multiple, up to thousands of samples. Processing of all samples is done sequentially, sample after sample and may take several hours between the first to the last sample. Depending on the type of analysis it may be useful to maintain the samples at a defined temperature for example, to maintain viability and integrity of the sample or to keep biological processes running at physiological temperatures. The present invention allows to maintain the sample holder at definable temperatures between 3° C. to 70° C.

Peltier elements are thermoelectric devices that act as a heat pump and are composed of a hot plate and a cool plate connected by thermo couple. The Peltier element works in a way when electricity flows through, the system will transfer heat from one side to the other. The heat generated by the process has to be removed from the hot side of the Peltier element allowing the cool side to reach low temperatures. Specifically, in biomedical applications, Peltier elements are used in PCR (Polymerase chain reaction) systems to ensure a rapid switch of temperature. Similarly, Peltier elements are also used in microscopy imaging, particularly integrated in temperature controller systems to maintain the temperature of the systems below the room temperature.

A wide variety of flow cytometry devices have been developed in the past 10 to 20 years. Few cytometers in the market have temperature controlled plate loaders. However, these devices usually work by heated, cooled water circulated in them which has the disadvantage of running water though an electronic machine which can cause sever issues if the circuit becomes leaky. Similarly, the response time to adjust the temperature very long as the entire water reservoir has to be initially brought to temperature. In addition, in most cases it requires a separate cooled/heated water-bath which occupies more space.

A patent (U.S. Pat. No. 8,431,390B2) entitled “Systems of sample processing having a macro-micro interface” disclosed a nucleic acid sample processing and analysis system. The patent further disclosed a microchip interface device that can include a heater, such as a resistive heater like nichrome, a Peltier heater, an air-based heater, an infrared heater, or other embodiments well known to one skilled in the art and thermocouple or other temperature measurement device and associated control circuitry and software to control the temperature and heating and cooling rates of a region of the microchip. Cooling can be by radiant cooling, active cooling from a fan, cooling by a Peltier, cooling by water or other methods well known to one skilled in the art. The temperature of the entire microchip can also be set by heating the vacuum chuck. However, the above prior art is restricted the use of Peltier heater for the temperature control of microchip. The provided prior art failed to disclose the use of Peltier heating system for directly maintaining the temperatures of biological samples and the present invention should be considered to be non-obvious over disclosed prior art.

None of the prior art inventions and patents, taken either alone or in combination, is effective to overcome the identified defects of efficiently maintaining the temperature of large numbers of biological samples. Most temperature controlling systems of the prior art do not provide specific efficient temperature control systems to maintain the temperatures of biological samples.

Hence, the present invention proposes to resolve the existent technical difficulties to eliminate the shortcomings of prior art. The present invention provides an apparatus that further consists of at least one Peltier module mounted underneath a surface of a multi sample holding device such as a micro titer plate. The temperature of the surface is measured at defined rates and voltage and/or current supplied to the Peltier elements is adjusted by a microcontroller to maintain temperature within defined limits.

### SUMMARY OF THE INVENTION

Embodiments of the invention solve the above-mentioned problems by providing a thermoelectric temperature controlled sample holder for biomedical analyzers. The thermoelectric temperature controlled sample holder comprises of at least one Peltier module mounted underneath a surface of a multi sample holding device such as a micro titer plate. The temperature of the surface is measured at defined rates and voltage and/or current supplied to the Peltier elements is adjusted by a microcontroller to maintain temperature within defined limits. The micro controller further measures the temperature of the temperature controlled plate and compares it against a target temperature that the user sets in a software interface.

If the plates temperature differs from the target temperature, the microcontroller adjusts an output current and voltage to power at least one Peltier element to reach the target temperature. Similarly, if the target temperature is reached the micro controller modulates the output current and voltage to keep the temperature at the target temperature.

Peltier elements in general generate a defined maximum temperature differential between their hot and their cold side. At the same time, they are very inefficient and thus produce a lot of heat during their operation. The heat removal generated by the peltier elements is one of the crucial factors of the invention. Due to the small form factor, the heat sink has to be relatively small. The heat sink made of a vapor chamber combined with high performance cooling fans has been used to remove the excess generated heat from the system.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWINGS

Embodiments of the invention are described in detail below with reference to the attached drawing figures, wherein:

FIG. 1 is an explosive view of thermoelectric temperature controlled sample holder.

FIG. 2 provides multiple views of thermoelectric temperature controlled sample holder.

FIG. 3 provides visualization of the 96 well plate placed on the surface of temperature control plate.

### DETAILED DESCRIPTION OF THE INVENTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, embodiments of the invention can include a variety of combinations and/or integrations of the embodiments described herein.

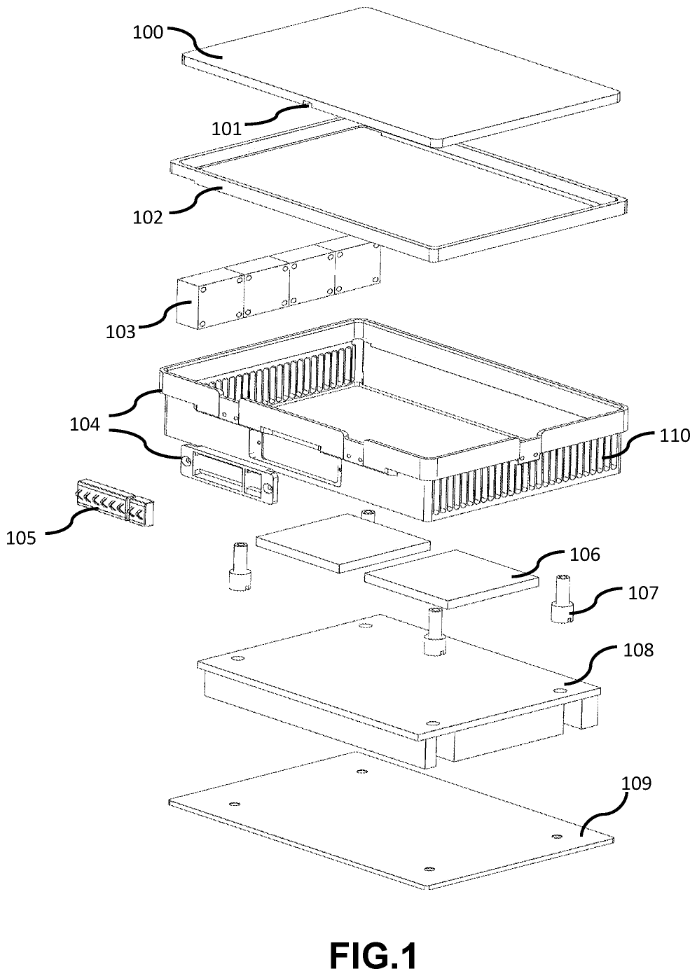

Turning to the figures and specifically FIG. 1, embodiments of the present invention comprise a temperature controlled plate 100 where in, the said temperature controlled plate 100 further comprises an upper surface and a lower surface. The lower surface of the said temperature controlled plate 100 further comprises integrated temperature sensor 101. A thermal insulation 102 is used to enclose the temperature controlled plate 100. Additionally, cooling fans 103 are placed at the inner surface of the enclosure 104 to remove the heat from the heat sink. The cooling fans and heat sink are further enclosed with slits for ventilation and heat removal by cooling fans and heatsink 110. Additionally, a connector 105 is placed at the enclosure 104 which is used for connecting the micro-controller. The system further comprises a thermoelectric element 106 and plurality of heat sink mounts 107. The lower surface of the thermoelectric element is place on the heat sink 108 which is further enclosed using an enclosure 109 from the lower part of system.

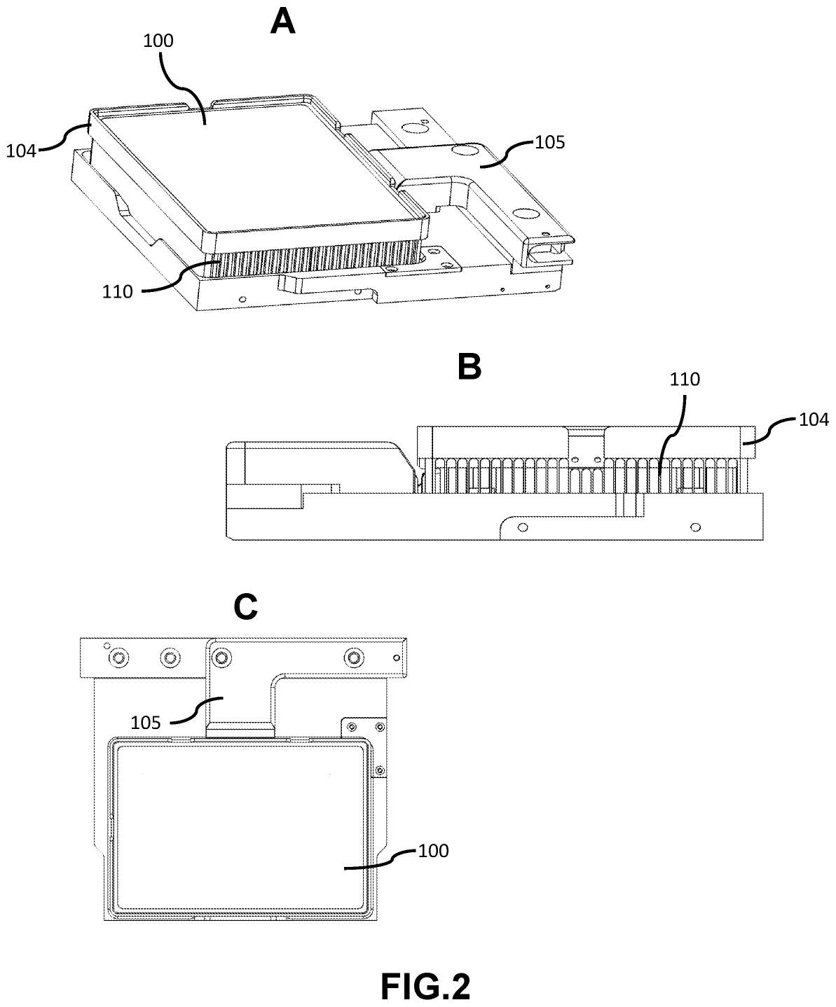

Now referring to FIG. 2A that provides a perspective view of the thermoelectric temperature controlled sample holder, where in further visualizing temperature controlled plate 100, enclosure 104, slits for ventilation and heat removal by cooling fans and heatsink 110 and connector to microcontroller 105. Additionally, FIG. 2B provides a side view of the thermoelectric temperature controlled sample holder, where in further visualizing enclosure 104 and slits for ventilation and heat removal by cooling fans and heatsink 110. Similarly, FIG. 2C provides top plan view of the thermoelectric temperature controlled sample holder, where in further visualizing temperature controlled plate 100 and connector to microcontroller 105.

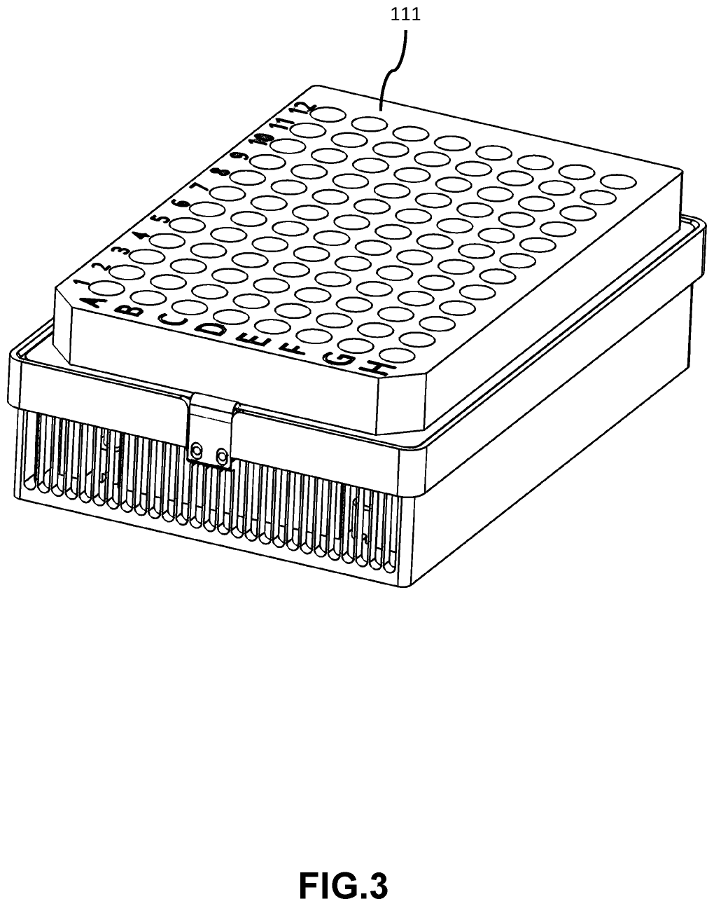

Referring to FIG. 3, thermoelectric temperature controlled sample holder is used to control the temperature of a 96 well plate 111 placed on the upper surface of temperature controlled plate 100.

In one embodiment of the present invention, at least one Peltier module is mounted underneath a surface that multi sample holding device such as a micro titer plate sits on during analysis. The temperature of the surface is measured at defined rates and voltage and/or current supplied to the Peltier elements is adjusted by a microcontroller to maintain temperature within defined limits.

In another embodiment of the present invention, maintaining the temperature of biological samples such as cell suspensions from tumor isolates or blood at low temperature such as 4° C. for instance reduces metabolic activity and thereby inhibits processes like programmed or necrotic cell death. Moreover, it reduces the degree of membrane turnover and thereby stabilizes antibody surface staining compared to not keeping the sample cooled. Specifically, keeping the sample at physiological temperatures such as 37° C. during analysis allows for live “time lapsed” assays of physiological processes such as killing assays, phagocytosis assays, heat shock and others.

In further embodiment of the present invention, If the plates temperature differs from the target temperature, the microcontroller adjusts an output current and voltage to power at least one Peltier element to reach the target temperature. Similarly, if the target temperature is reached the micro controller modulates the output current and voltage to keep the temperature at the target temperature.

In another embodiment of the present invention, Peltier elements in general generate a defined maximum temperature differential between their hot and their cold side. At the same time, they are very inefficient and thus produce a lot of heat during their operation. The heat removal generated by the Peltier elements is one of the crucial factors of the invention. Due to the small form factor, the heat sink has to be relatively small. The heat sink made of a vapor chamber combined with high performance cooling fans has been used to remove the excess generated heat from the system.

In some of the embodiments of the present invention, all the above specified hardware are monitored and controlled using a software application that can be installed into a computer are similar means.

In further embodiment of the present invention, the temperature controlling apparatus allows to maintain the sample holder at definable temperatures between 3° C. to 70° C.

Although embodiments of the invention have been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An apparatus for automated temperature controlling of a plurality of biological samples, said apparatus comprising:
a) a temperature controlled plate,
where in the said temperature controlled plate further comprises an upper surface and a lower surface,
where in the lower surface of the said temperature controlled plate further comprises integrated temperature sensor,
b) a thermal insulation used to enclose the said temperature controlled plate,
c) at least one cooling fan placed at the inner surface of the enclosure to remove the heat from the heat sink,
d) an external enclosure that covers the outer circumference of the said apparatus,
e) a connector for connecting the micro-controller,
f) at least one thermoelectric element,
g) at least one heat sink mount,
h) at least one heat sink, and
i) a lower enclosure that encloses the lower part of the apparatus.
j) a computer comprising software programmed to fully automate processes performed by the said automated temperature controlling apparatus.

2. The temperature controlling apparatus according to claim 1,
wherein the said apparatus maintain samples at definite temperature for further analysis.

3. The temperature controlling apparatus according to claim 1,
wherein the said temperature controlled plate is a Peltier element which is mounted underneath a surface that multi sample holding device such as a micro titer plate sits on during analysis.

4. The temperature controlling apparatus according to claim 1,
wherein the said temperature of the surface is measured at defined rates, voltage and current supplied to the Peltier elements is adjusted by a microcontroller to maintain temperature within defined parameters.

5. The temperature controlling apparatus according to claim 1,
wherein the said apparatus allows to maintain the sample holder at definable temperatures between 3° C. to 70° C.

6. The temperature controlling apparatus according to claim 1,
wherein the said apparatus is used to control the temperature of a 96 well plate.
